(19) United States
(12) Patent Application Publication
(10) Pub. No.: US 2002/0085876 A1
(43) Pub. Date: Jul. 4, 2002

(54) Ring binder having torsionally stiffened blades

(76) Inventor: Chung Nin Ko, Kowloon (HK)

Correspondence Address: Charles Fallow, Esq., Shoemaker and Mattare, Ltd., 2001 Jefferson Davis Highway, Arlington, VA, 22202, US

(21) Appl. No.: 09/750,230

(22) Filed: Dec. 29, 2000

(51) Int. Cl. B42F 3/04; B42F 13/20

(52) U.S. Cl. 402/31

(57) ABSTRACT

The blades of a ring binder are torsionally stiffened by stamped grooves extending lengthwise of the blades, so that trigger-induced angular displacement of either end of the blades is transferred to the center of the blades, allowing them to snap the rings open or closed.

### BACKGROUND OF THE INVENTION

This invention relates to a ring binder for securing loose-leaf papers.

Ring binders are manufactured and distributed today by only a few manufacturers. The production volumes are so high, and the market so competitive, that minor unit cost reductions can be very important. One way or reducing costs is to use less raw material, for example by reducing the gauge of sheet metal parts of ring binders.

A typical ringer binder has a sheet metal housing which is longitudinally stiff, but laterally flexible, and contains a pair of blades which are hinged along mating edges. Each blade supports a number of ring halves. The blades have a combined width slightly greater than the width of the housing, so that they toggle between two extreme positions, in one of which the tips of the ring halves meet, forming closed rings, and in another of which the ring halves are open, allowing one to insert or remove loose-leaf papers.

Many ring binder mechanisms may be opened or closed by triggers which, when manipulated, move the blades between the two extreme positions. The triggers are arranged at the end of the housing in such a way that they push up or down on the blades near their end points. Because the trigger force is applied only at the ends of the blades, and the resisting forces are distributed along the length of the blades, the blades twist somewhat when the triggers are operated. The mechanism can function properly only if the blades have sufficient torsional stiffness that they are displaced at their centers to a point where the blades snap through from one rest position to the other. This toggle action will not occur if the angular displacement at the middle of the blade is lower than the snap-through angle, even though the blade ends may have been displaced far beyond that angle.

If the blade is insufficiently stiff, the twisting at the blade tip will reach its maximum without triggering the snapping action of the ring binder. The maximum angle is where the trigger touches the housing during opening.

Thus, it is important for the blade to have a certain minimum torsional stiffness. The actual value of the stiffness depends on variables such as the side of the housing, the stiffness of the housing, and the maximum blade angle. One way to improve blade stiffness is to use stiffer materials (higher modulus of elasticity); another is increase blade thickness. But thick blades are more costly, and result in heavier mechanisms which cost more to ship. It is therefore desirable to increase the torsional stiffness of blades without increasing their thickness or weight.

### SUMMARY OF THE INVENTION

One way to increase blade stiffness, without increasing the gauge of its metal, is to stamp reinforcing grooves or ridges into it. The most efficient groove for this purpose has been found to be a long, continuous, straight groove, with as little interruption as possible. Every break or interruption in the groove reduces the torsional stiffness of the blade. Unfortunately, other design considerations make it impossible to provide uninterrupted grooves running the fill length of the mechanism. Where the ends of the ring halves are secured to the plates, for example, it is inconvenient or impossible to have grooves. Nevertheless, it is a design goal to make the grooves as long as possible, extending as near as possible to the center of the blade.

An object of the invention is to improve the torsional stiffness of a ring-supporting blade in a ring binder mechanism. A related object is to improve the actuating feel of the mechanism. Another object is to minimize the mass of a ring binder blade.

These and other objects are attained by a ring binder having torsionally stiffened blades. The blades are preferably stiffened by stamping or embossing them, preferably with plural ribs running lengthwise of the blades.

### BRIEF DESCRIPTION OF THE DRAWINGS

In the accompanying drawings,

FIG. 1 is a side elevation of a ring binder having torsionally stiffened blades embodying the invention;

FIG. 2 is a bottom plan view thereof;

FIG. 3 is a top plan view, with most of the metal housing broken away to reveal the underlying detail;

FIG. 4 is a sectional view taken on the plane A-A in FIG. 3;

FIG. 5 is a sectional view taken on the plane B -B in FIG. 3;

FIG. 6 is a bottom plan view of one blade element; and

FIG. 7 is a sectional view taken on the plane C-C in FIG. 6.

### DESCRIPTION OF THE PREFERRED EMBODIMENT

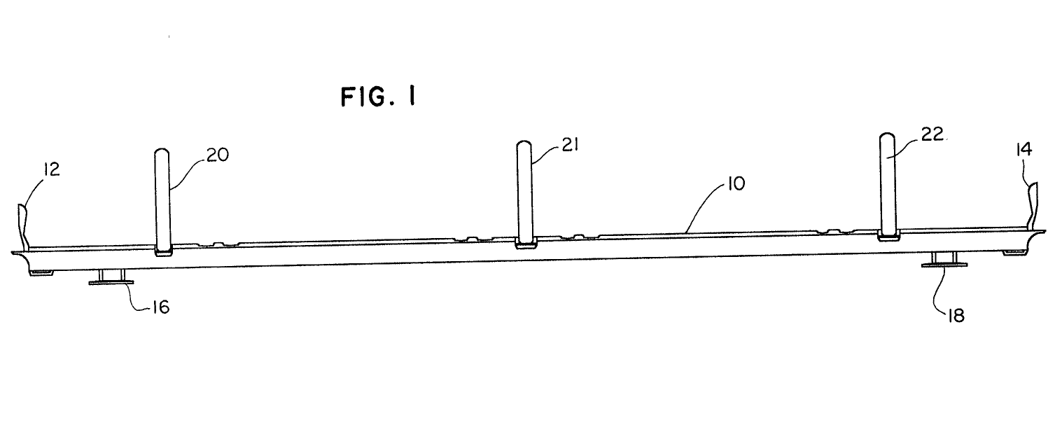

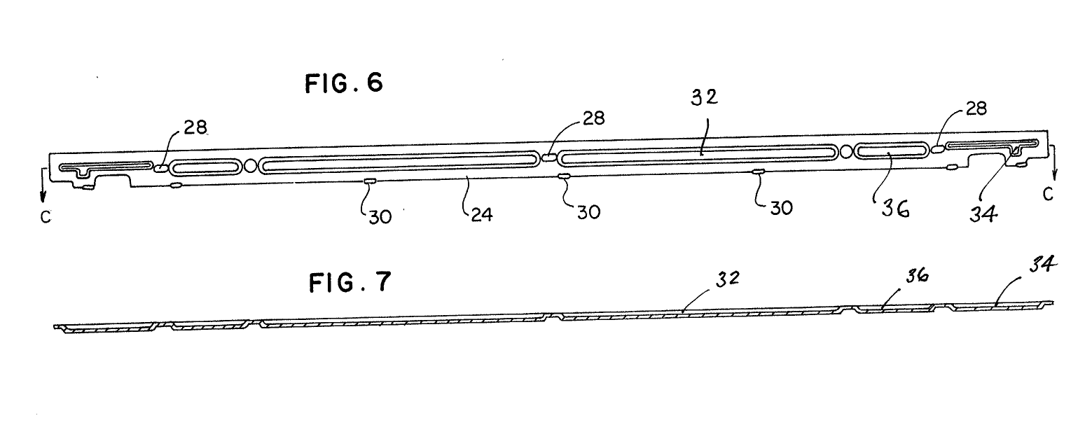

A ring binder embodying the invention, as shown in FIG. 1, includes a metal housing 10 which supports opposed triggers 12, 14 at either end. Rivets 16, 18 having their upper ends secured in holes in the housing, extend downward, for connecting the housing to the spine of a ring binder. The rings 20, 21, 22 each comprises two half-rings whose lower ends are secured to the respective blades 24, 26, by crimping, swaging or staking, within elliptical holes 28 one can see in FIG. 6. The holes 38 are provided for engagement by fixtures during manufacture.

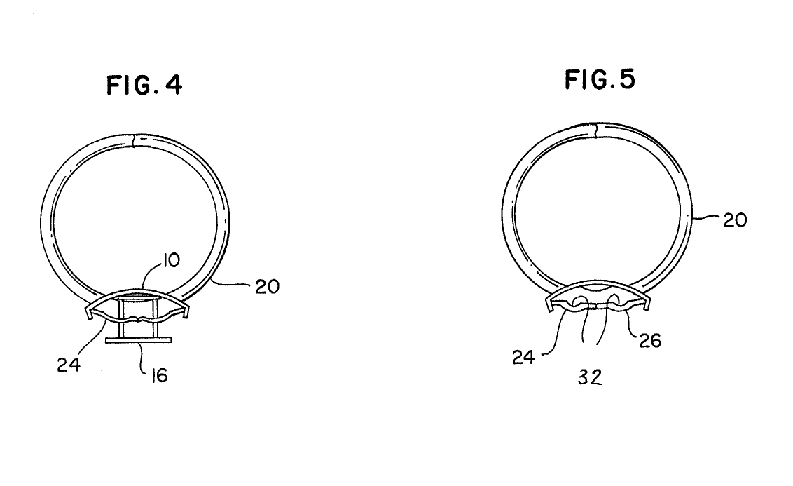

In FIGS. 4 and 5, one can see the two blades 24, 26, their inner edges abutting, and being retained in alignment by alternating tab-like deformations 30 (FIG. 6) formed along the inner edges. In FIGS. 4 and 5, the rings are closed, the inner edges of the blades being below an imaginary plane containing the outer edges of the blades. When the rings are opened, the inner edges are above that plane. The extremes of upward and downward movement are determined by mechanical stops or interference between parts, not illustrated.

The triggers are mounted for pivotal movement at the ends of the housing. Details of the mounting, and of the interaction between the triggers and the blades, are not shown, there being a great number of suitable well-known variations. In any event, the triggers have a portion which engages the blades at or near their inner edges, near the ends of each blade. When the triggers are moved in either direction, they displace the ends of the blades upward or downward. This displacement is transferred by torsion along the lengths of the blades, the displacement at the center being less than at the trigger end, because of the torsional flexibility of the blades. To ensure proper operation, it is desirable that the blades have high torsional stiffness.

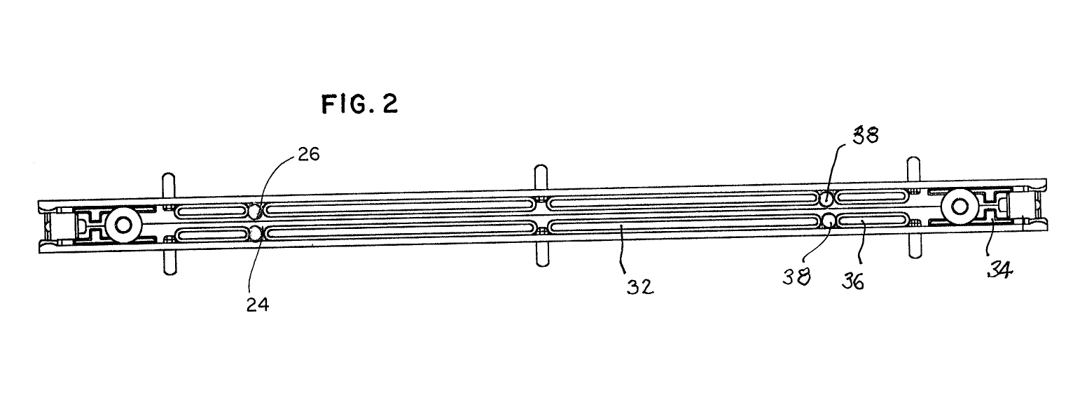

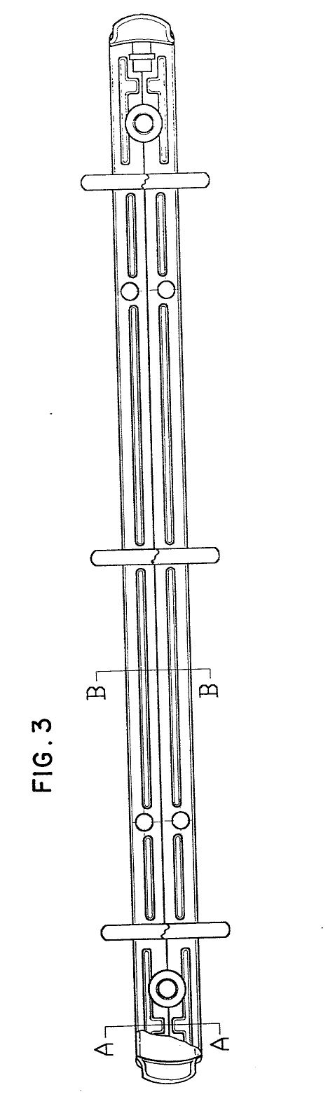

The grooves 32, 34, 36 illustrated in FIGS. 2, 3, 6 and 7 increase the blades' torsional rigidity. The width of the grooves is between 10% and 90% of the blade width, preferably about ⅓ of the blade width. The groove depth may be smaller or greater than the blade thickness. Lengthwise, the grooves are as nearly contiguous as possible, their aggregate length being at least one-half of the blade length. A substantial increase (as compared to a flat blade) in torsional rigidity results.

Since the invention is subject to modifications and variations, it is intended that the foregoing description and the accompanying drawings shall be interpreted as only illustrative of the invention defined by the following claims.

I claim:

1. A blade for supporting ring halves in a ring binder, said blade being formed of sheet metal and having deformations extending out of the plane of the sheet metal thereby increasing the torsional stiffness of the blade.

2. The invention of claim 1, wherein each of said deformations is a straight groove.

3. The invention of claim 2, wherein said groove extends lengthwise of the blade.

4. The invention of claim 3, wherein said grooves are arranged in parallel pairs.

5. The invention of claim 3, wherein said grooves are arranged in plural parallel pairs aligned along the length of the blade.

6. The invention of claim 5, wherein said aligned grooves extend substantially the whole length of the blade.

7. A method of increasing the torsional stiffness of a blade in a ring binder, said method comprising impressing a flat sheet metal blade with at least one deformation extending out of the plane of the sheet metal.

8. The invention of claim 7, wherein each of said deformations is a straight groove.

9. The invention of claim 8, wherein said groove extends lengthwise of the blade.

10. The invention of claim 9, wherein said grooves are arranged in parallel pairs.

11. The invention of claim 9, wherein said grooves are arranged in plural parallel pairs aligned along the length of the blade.

12. The invention of claim 11, wherein said aligned grooves extend substantially the whole length of the blade.

13. In a ring binder mechanism comprising
a flexible metal housing containing
a pair of sheet metal blades which are laterally aligned and have mating inner edges retained in alignment with one another by tab-like deformation, thereby forming a hinge connection between said inner edges,
a pair of triggers mounted at opposite ends of the housing, each trigger having a portion engaging said blades at or near their inner edges,
said blades having a greater combined width than that of said housing, so that the blades toggle between upper and lower extreme positions when forced to do so by movement of said triggers,
plural pairs of opposed ring halves, each affixed to a respective one of said blades so hat tips of the ring halves meet when the blades are in one extreme position, and open when the blades are in another extreme position, the improvement wherein
said blades are formed of sheet metal and have deformations extending out of the plane of the sheet metal thereby increasing the torsional stiffness of the blade.

14. The invention of claim 13, wherein each of said deformations is a straight groove.

15. The invention of claim 14, wherein said groove extends lengthwise of the blade.

16. The invention of claim 15, wherein said grooves are arranged in parallel pairs.

17. The invention of claim 15, wherein said grooves are arranged in plural parallel pairs aligned along the length of the blade.

18. The invention of claim 17, wherein said aligned grooves extend substantially the whole length of the blade.
